(19) United States
(12) Patent Application Publication
(10) Pub. No.: US 2014/0054051 A1
(43) Pub. Date: Feb. 27, 2014

(54) TILLAGE IMPLEMENT WITH RAISABLE SOIL-LEVELING CYLINDERS

(71) Applicant: Landoll Corporation, Marysville, KS (US)

(72) Inventors: Donald R. Landoll, Marysville, KS (US); Dirk E. Nichols, Beloit, KS (US)

(73) Assignee: Landoll Corporation, Marysville, KS (US)

(21) Appl. No.: 14/011,608

(22) Filed: Aug. 27, 2013

Related U.S. Application Data
(60) Provisional application No. 61/693,702, filed on Aug. 27, 2012.

(51) Int. Cl. A01B 63/00; A01B 29/00

(52) U.S. Cl. CPC A01B 63/008; A01B 29/00
USPC 172/170

(57) ABSTRACT

A tillage implement with raisable soil-leveling reels includes a main frame, which can include a center section and wing sections hingedly connected to the center section. The wing sections are adapted for being hydraulically rotated and raised from generally horizontal field positions to transport/storage positions. Gangs of earth-working tools, such as coulter discs or tines, are mounted on the wing sections. The soil-leveling reels are mounted on trailing arm assemblies, which are adapted for raising and lowering the reels between raised, transport/storage positions and lowered, field-engaging positions. Hydraulic piston-and-cylinder units are connected to compression springs and adapted for raising and lowering the arm assemblies and the reels. The compression springs absorb and dampen jolts and impacts from field irregularities and transport motion-induced forces, thus protecting the piston-and-cylinder units.

### CROSS-REFERENCE TO RELATED APPLICATION

This application claims priority in U.S. Provisional Patent Application Ser. No. 61/693,702, filed Aug. 27, 2012, which is incorporated herein by reference.

### BACKGROUND OF THE INVENTION

1. Field of the Invention

The present invention relates generally to a tillage implement with soil-leveling reels or cylinders, which can be raised and lowered between transport and soil-working positions.

2. Description of the Related Art

Tillage implements are generally towed behind tractors and can be equipped with one or more leveling reels or cylinders for conditioning and leveling the soil behind the implement during a tilling operation. The present invention relates to a tillage implement with conditioner reels adapted for raising and lowering relative to the implement frame. For example, the reels can be raised when wet and muddy field conditions are encountered, and lowered when operating in relatively dry field conditions. Adjustable-pressure hydraulic piston-and-cylinder units are provided for raising and lowering the reels, which are also suspended with compression springs for maintaining downward pressure and ground contact when uneven field conditions are encountered.

### SUMMARY OF THE INVENTION

In the practice of an aspect of the present invention, a tillage implement is provided with a main frame mounting earth-working tools, such as gangs of coulter discs, tines, etc. Conditioner reels are mounted on trailing arm assemblies, which are connected to the main frame. Each trailing arm assembly includes a piston-and-cylinder unit connected to a compression spring and adapted for raising and lowering the ground-leveling reel. The compression springs function to absorb impacts from field obstacles and transport forces, thereby minimizing impacts on and protecting the piston-and-cylinder units.

### BRIEF DESCRIPTION OF THE DRAWINGS

The drawings constitute a part of this specification and include exemplary embodiments of the present invention illustrating various objects and features thereof.

FIG. 1 is an upper, front, perspective view of a tillage implement with soil-leveling conditioner reels, which are adapted for raising and lowering between use and transport positions, embodying an aspect of the present invention.

FIG. 2 is another upper, front, perspective view of the tillage implement.

FIG. 3 is a fragmentary, side elevational view showing a reel in its normal, lowered, field-engaging position.

FIG. 4 is a fragmentary, side elevational view showing the reel in its raised, disengaged, transport position.

FIG. 5 is an upper, front, perspective view of a tillage implement embodying an alternative embodiment of the present invention with a soil-leveling reel or cylinder mounted on the implement.

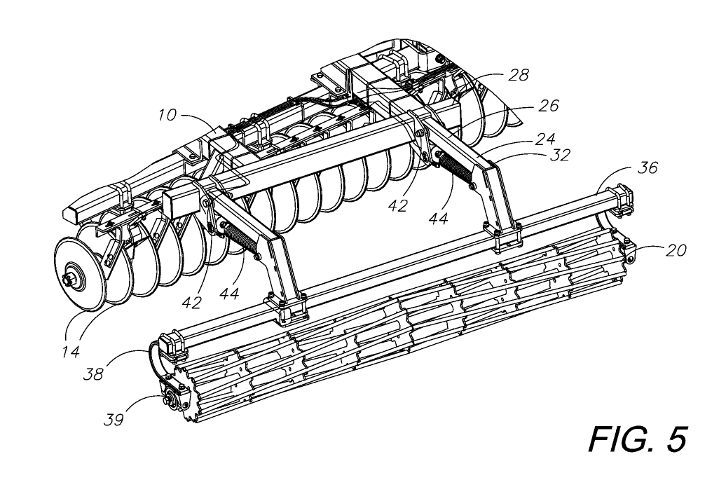

### DETAILED DESCRIPTION OF THE PREFERRED EMBODIMENTS

As required, detailed aspects of the present invention are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

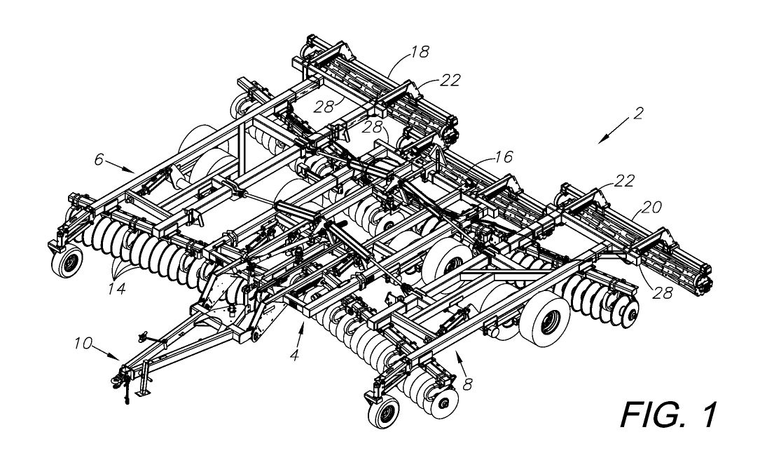

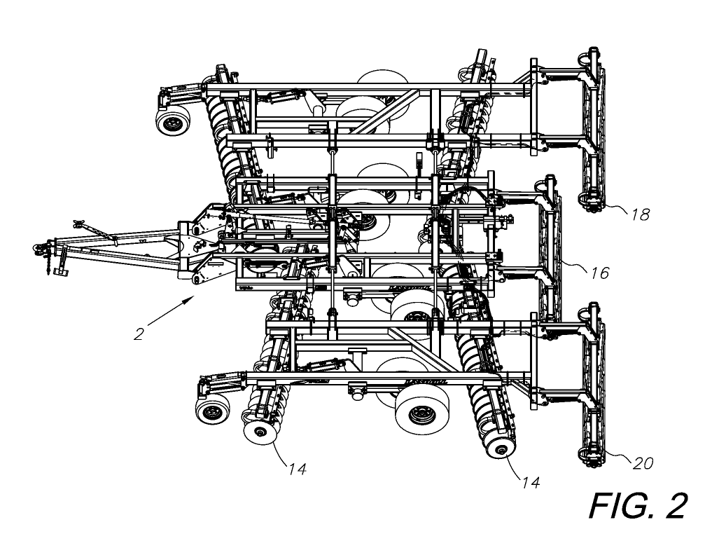

Referring to the drawings in more detail, the reference numeral 2 generally designates a tillage implement including a center section 4 and wing sections 6, 8, which are hingedly connected to and adapted for folding upwardly and inwardly relative to the center section 4 to configure the implement 2 for transport and storage. In a working, field position, as shown in FIGS. 1 and 2, the wing sections 6, 8 are generally horizontal and coplanar with the center section 4. Various combinations and configurations of implements can be utilized with the raisable reels of the present invention. For example, the disc gangs can be overlapped and staggered relative to each other. This configuration can eliminate the need for a center clean-up shank. The disc gangs can be optimally angled with respect to the implement direction of travel for maximizing proficiency and field coverage. The disc gang angular orientation can be chosen for desired field-working effects.

The implement 2 includes a main frame 10, which is adapted for mounting field-working tools, such as gangs of coulter discs 14. Various other combinations of earth-working tools can be mounted on the main frame 10, such as tines, shovels, chisels, knives, sweeps, fertilizer injectors, etc. Such ground-working tool configurations are typically chosen for specific fields, crops, growing seasons and related conditions.

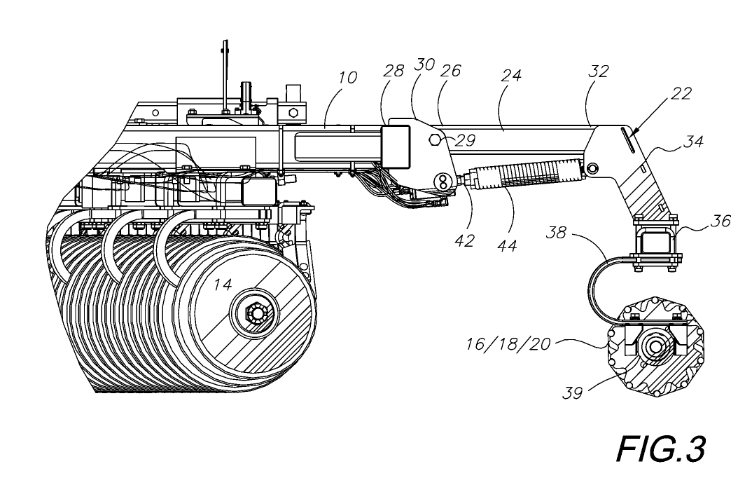

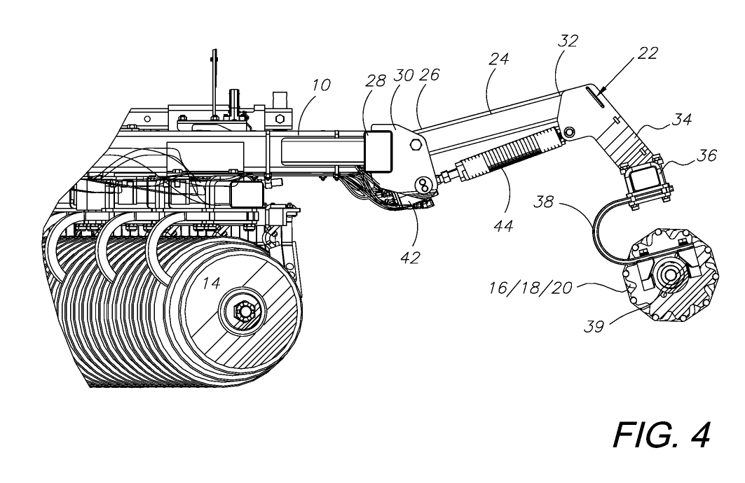

The implement 2 also includes soil-leveling, conditioner cylinders or reels 16, 18 and 20, which are mounted behind the implement sections 4, 6 and 8, respectively. The reels 16, 18, 20 are rotatably mounted on trailing arm assemblies 22, which are adapted for raising and lowering the reels 16, 18, 20 between their lowered, field-engaging positions (FIG. 3) and their raised, transport/storage positions (FIG. 4). Each arm assembly 22 includes an arm member 24 with a front end 26 mounted on a transverse toolbar 28 of the main frame 10 by an arm pivot bolt 29 extending through a clevis assembly 30. The arm pivot bolt 29 is aligned with a generally horizontal, transverse pivotal axis of the arm assembly 22. Each arm member 24 includes a trailing, back end 32 mounting a downwardly and rearwardly extending bracket 34, which terminates at a transverse, generally horizontal toolbar 36. The conditioner reels 16, 18, 20 are mounted on the toolbars 36 by C-flex gang hangers 38 and bearings 39 located at each end of the reels 16, 18, 20. Alternative configurations of conditioner reels could be provided on the implement 2, including power-driven reels and various tool configurations adapted for specific ground-working tasks.

The tillage implement 2 can be configured with various widths. For example, two conditioner reels can be provided instead of the three reels shown. Still further, the tillage implement can be configured as a relatively narrow rigid frame implement without folding wing sections.

In its operating position (FIG. 3), the arm member 24 extends generally horizontally rearwardly from the clevis assembly 30, which mounts a hydraulic piston-and-cylinder unit 42, which is connected to a helical compression spring 44. The piston-and-cylinder units 42 cooperate with the compression springs 44 to control the downward pressure on the conditioner reels 16, 18, 20. For example, fully retracting the piston-and-cylinder unit 42 fully loads the conditioner reel and the compression spring 44. The lowered and raised positions of the conditioner reels 16, 18, 20 shown in FIGS. 3 and 4 respectively, and the respective downward pressures, are adjustable by changing the overall length of the piston-and-cylinder unit 42 and the compression spring 44. For example, the spring length 44 can be minimized with the conditioner reel lowered (FIG. 3) for maximizing the downward pressure and the soil-working effect by utilizing the full weight of the conditioner reels 16, 18, 20. This configuration can be considered a more “aggressive” implement setting. Conversely, extending the springs 44 relative to the piston-and-cylinder units 42 tends to off-load the cylinders or reels 16, 18, 20 for a less aggressive setting.

An important advantage of the arm assembly 22 configuration and function relates to minimizing the effects of bouncing the raised cylinders 16, 18, 20, particularly while transporting the implement 2 over rough and undulating field surfaces. Such motions alternately apply compression and tension forces to the piston-and-cylinder unit 42. The spring 44 acts as a shock absorber to minimize the effects of such forces. In addition to leveling the field and breaking clods, the implement 2 is adapted for distributing residue from previous crops.

It is to be understood that the invention can be embodied in various forms, and is not to be limited to the examples discussed above. The range of components and configurations which can be utilized in the practice of the present invention is virtually unlimited.

Having thus described the disclosed subject matter, what is claimed as new and desired to be secured by Letters Patent is:

1. A tillage implement including:
a main frame adapted for connection to a tow vehicle;
multiple earth-working tools mounted on the main frame;
a conditioner reel including opposite ends and earth-leveling structure extending between the ends;
a pair of trailing arm assemblies each mounted on the mainframe and extending rearwardly therefrom;
each said trailing arm assembly being connected to a respective conditioner reel end;
a pair of hydraulic piston-and-cylinder units each mounted on a respective trailing arm assembly and connected to the main frame;
a pair of compression springs each having a first end connected to a respective piston-and-cylinder unit and to a respective trailing arm assembly;
said trailing arm assembly having a raised position with said piston-and-cylinder unit extended and a lowered position with said piston-and-cylinder unit retracted;
said conditioner reel raised above a field surface in a transport/storage position with said trailing arm assemblies in their raised positions; and
said conditioner reel adapted for engaging a field surface in a working position with said trailing arm assemblies in their lowered positions.
